(19) United States
(12) Patent Application Publication
(10) Pub. No.: US 2013/0256237 A1
(43) Pub. Date: Oct. 3, 2013

(54) WATER SOLUBLE PACKAGE FILMS FOR ACIDIC HIGH WATER CONTENT PRODUCT AND METHOD OF PRODUCING THE SAME

(71) Applicants: Linna Wang, Shanghai (CN); Guixi Zhang, Shanghai (CN)

(72) Inventors: Linna Wang, Shanghai (CN); Guixi Zhang, Shanghai (CN)

(21) Appl. No.: 13/128,476

(22) PCT Filed: Dec. 20, 2010
(86) PCT No.: PCT/CN10/02085

§ 371 Date: May 10, 2011

(51) Int. Cl. B65D 85/84; C02F 1/68

(52) U.S. Cl. CPC B65D 11/00; C02F 1/68
USPC 210/749; 206/524.2

(57) ABSTRACT

A packaging system for an acidic product and a method for adding the acid product to a water system, wherein the packaging system has a multi-layer packaging film with a water-soluble outer layer and an inner layer comprising a pH-sensitive polymer. The inner layer is stable at the pH of the acidic product and dissolves when exposed to a pH greater than dissolution pH of the inner layer, the dissolution pH being greater than the pH of the acidic product. In one example, the dissolution pH of the inner layer is between 5 to 8. When the pH of the water system reaches the dissolution pH, the product is released to the water system.

### BACKGROUND OF THE INVENTION

1. Field of the Invention

This invention relates generally to water-soluble packaging, and more particularly, to water-soluble packaging for acidic products with environmental triggered dissolution properties.

2. Description of Related Art

Water treatment chemicals are used to combat biofouling, scaling, corrosion and other problems in industrial water systems. When encapsulated in a package having a water-soluble film, these treatment products can be directly added to the water systems. A unit dose of a product is encapsulated in the water-soluble film, and upon exposure to water or other aqueous media, the water-soluble film dissolves and releases the product. This form of packaging provides precise dosing, convenient application and safe handling for many types of water treatment chemicals, including highly reactive materials, such as biocides, fertilizers, dyes, surfactants, and other types of additives.

However, using water-soluble films to package products containing water or other aqueous media poses several difficulties. The water from the product can leak or seep into the water-soluble film, causing it to deteriorate and eventually compromise the integrity of the package. Typically, modifications have to be made to the product to either significantly reduce water content to less than about 5%, employ a non-aqueous solvent, formulate product into a water-in-oil emulsion, or to add large amount of water binding polymers or salts. Alternately, modifications have to be made to the film compound. These modifications can be costly, time-consuming and affect the properties of the product or the film.

Additionally, it is often desirable to pre-feed treatment chemicals into the water systems as it is desirable to combat problems when they arise and while they are small rather than after they have become a serious issue. However, this often results in the overfeeding of chemicals, which is less economical and can have a higher environmental impact.

European Patent Application No. EP-A-518689 discloses a containerization system for hazardous materials comprising a PVOH film enclosing a composition comprising the hazardous material, water, and electrolyte and optional other material. The electrolyte is added to reduce the solubility of the film to prevent its dissolution by the packaged compositions. U.S. Pat. No. 4,973,416 discloses a PVOH package containing a liquid laundry detergent composition comprising from about 10% to about 24% by weight of water. Several prior arts described that by modifying the water containing formulation, a conventional water-soluble film can be employed as primary packaging. For example, U.S. Pat. No. 6,037,319 discloses a liquid cleaner with up to 10% water content. U.S. Pat. No. 4,973,416 disclosed a formulation containing up to 24% water. U.S. Patent Publication No. 200600281658 described that by adding high percentage certain salt and nonionic surfactant conventional water-soluble packaging can tolerant up to 40% water by weight. WO03076513A1 discloses water-soluble polymeric materials that incorporate a salt or mineral nucleating agent and plasticizers so it can effectively act as the primary packaging for liquids, gels or pastes products containing 1-85% water by weight while keeping package integrity until the intended use of the product.

What is needed is an improved and stable water-soluble packaging for acidic products containing substantial amount (i.e., greater than 5%) of water that is responsive to environmental stimuli for environmental triggered dissolution. Such a packaging system would provide stable packaging for acidic water treatment products and could also effectively release pre-fed water treatment products when triggered by changes in the environment that are associated with a problem in the aqueous water system.

### SUMMARY OF THE INVENTION

One aspect of the invention is directed to a packaging system having a multi-layer packaging film for a high water content acidic product. The multi-layer packaging film includes a water-soluble outer layer and an inner layer having a pH-sensitive polymer that is stable at the pH of the acidic product and dissolves when exposed to a pH of greater than a dissolution pH. The dissolution of the pH-sensitive polymer can range from pH 5.5 to pH 7. The acid product has a pH of less than the dissolution pH.

Another aspect of the invention is a package system for an acidic product, the product encapsulated in a multi-layer packaging film having an outer layer attached to an inner layer. The outer layer is water-soluble, and the inner layer in contact with the product comprises a pH-sensitive polymer.

Another aspect of the invention is a method for adding an acidic product treatment chemical in a water-soluble packaging system to a water system. The method includes providing a multi-layer film having an outer layer attached to an inner layer, wherein the outer layer is water-soluble, and the inner layer comprises a pH sensitive polymer. The acidic product is encapsulated in a packaging system comprising the mufti-layer film such that the acidic product contacts the inner layer. The method also includes adding the packaging system to the water system and dissolving the outer layer of the multi-layer film on contact with the water system. The inner layer of the multi-layer film is dissolved when the pH of the water system reaches a trigger pH at which the polymer of the inner layer dissolves.

The present invention and its advantages over the prior art will become apparent upon reading the following detailed description and the appended claims with reference to the accompanying drawings.

### BRIEF DESCRIPTION OF THE DRAWINGS

The above mentioned and other features of this invention will become more apparent and the invention itself will be better understood by reference to the following description of embodiments of the invention taken in conjunction with the accompanying drawings, wherein:

FIG. 1 is a schematic of a packaging system encapsulating an acidic treatment product according to an embodiment of the invention; and

FIG. 2 is a graph showing the release of product using packaging systems according to an embodiment of the invention.

Corresponding reference characters indicate corresponding parts throughout the views of the drawings.

### DETAILED DESCRIPTION OF THE INVENTION

The invention will now be described in the following detailed description with reference to the drawings, wherein preferred embodiments are described in detail to enable practice of the invention. Although the invention is described with reference to these specific preferred embodiments, it will be understood that the invention is not limited to these preferred embodiments. But to the contrary, the invention includes numerous alternatives, modifications and equivalents as will become apparent from consideration of the following detailed description.

Approximating language, as used herein throughout the specification and claims, may be applied to modify any quantitative representation that could permissibly vary without resulting in a change in the basic function to which it is related. Accordingly, a value modified by a term or terms; such as “about”, is not limited to the precise value specified in at least some instances, the approximating language may correspond to the precision of an instrument for measuring the value. Range limitations may be combined and/or interchanged, and such ranges are identified and include all the sub-ranges included herein unless context or language indicates otherwise. Other than in the operating examples or where otherwise indicated, all numbers or expressions referring to quantities of ingredients, reaction conditions and the like, used in the specification and the claims, are to be understood as modified in all instances by the term “about”.

“Optional” or “optionally” means that the subsequently described event or circumstance may or may not occur, or that the subsequently identified material may or may not be present, and that the description includes instances where the event or circumstance occurs or where the material is present, and instances where the event or circumstance does not occur or the material is not present.

As used herein, the terms “comprises,” “comprising,” “includes,” “including,” “has,” “having” or any other variation thereof, are intended to cover a non-exclusive inclusion. For example, a process, method, article or apparatus that comprises a list of elements is not necessarily limited to only those elements, but may include other elements not expressly listed or inherent to such process, method, article or apparatus.

The singular forms “a,” “an” and “the” include plural referents unless the context clearly dictates otherwise.

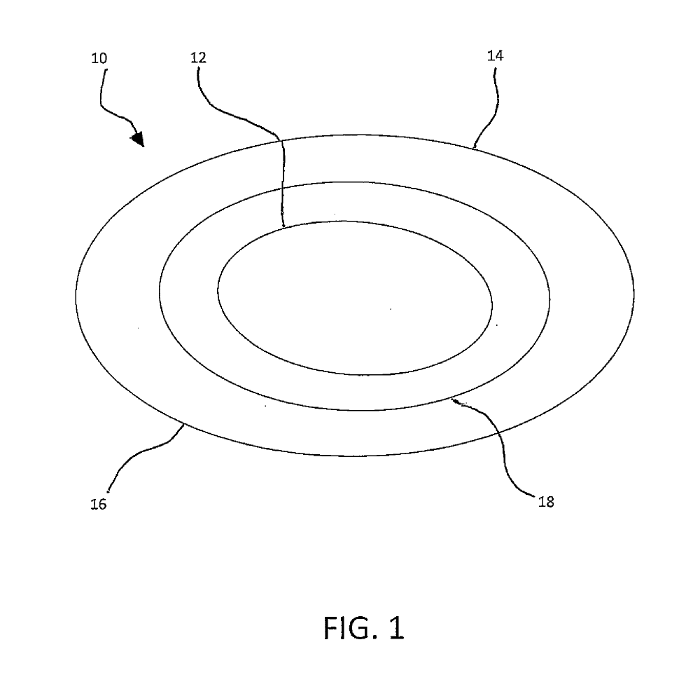

FIG. 1 shows an exemplary embodiment of a packaging system 10 used to encapsulate an acidic product 12 used for water treatment in industrial systems. While the invention will be described with respect to a packaging system 10 for an industrial water system, it is to be understood that the packaging system 10 may be used for consumer products, industrial products, agrochemical products, such as aquatic farming products, water treatment, such as environmental water treatment chemicals or drinking water treatment chemicals, or industrial water treatment, such as for cooling water, boiler water, waste water, pulp paper water or metal working fluid water without departing from the scope of the environment. The packaging system 10 includes a multi-layer film 14 having a water-soluble outer layer 16 and a protective inner layer 18. The packaging system 10 provide stable package for the acidic product 12 during storage and transport, but releases the acidic product 12 when triggered by an environmental property of the aqueous water system to which it is to be added. For example, in one embodiment described more fully below, the inner layer 18 of the film is stable within the lower pH ranges (i.e., pH of about 2 to 4) of the acidic product 12, but readily dissolves in higher pH (for example, a pH of about 5.5 or greater) environments such as the environment of an aqueous media to which the acidic product 12 it is to be added. Accordingly, a unit dose of the acidic product 12 can be added to the water system and the packaging system 10 dissolves under certain conditions to release the acidic product 12.

The acidic product 12 encapsulated by the packaging system 10 has a pH less than the dissolution pH of the pH-sensitive polymer. The acidic product 12 contains water or other aqueous media that is capable of dissolving a water-soluble film, The acidic product 12 has a water content of from about 5 percent to about 95 percent, based on the weight of the acidic product 12. In another embodiment, the acidic product 12 may have a water content of from about 20 percent by weight to about 80 percent by weight. In another embodiment, the product may have a water content of from about 50 percent by weight to about 75 percent by weight. The acidic product 12 desirably is a liquid chemical or biocide to be used in aqueous media such as a cooling water and for microbiological control. One example of a suitable liquid biocide is isothiazoline (commercial name Kathon® 886F). Although one skilled in the art will understand that any acidic product 12 used for water treatment of industrial waters may be used in the packaging system 10 without departing from the scope of the invention.

The outer layer 16 of the multi-layer film 14 is a water-soluble film. In one embodiment, the water-soluble film may be any type of conventional water-soluble film that dissolves in water or other aqueous media. The water-soluble film may be polyvinyl alcohol (PVA, PVAL, or PVOH). The water-soluble film may also be made from modified starch, modified cellulose, modified chitosan, polyethylene oxide, poly(ethylene oxide-co-propylene oxide), poly ethylene glycol, pollulan, gelatin, hydroxypropyl methylcellulose, proteins, polypeptides, or other water soluble polymers and their derivatives known to those skilled in the art. The water-soluble film may be prepared in any conventional manner known to those skilled in the art. In one embodiment, the water-soluble film may be prepared by solution casting. A solution of polyvinyl alcohol is prepared by adding polyvinyl alcohol to a suitable solvent, and the solution is cast into a film on a substrate. The film is dried, and the solvent is allowed to evaporate. One skilled in the art will understand that other suitable water-soluble films may be used for the outer layer 16.

The outer layer 16 is attached to the protective inner layer 18 made from a polymer coating having environmentally triggered dissolution properties. It is known that polymers can be fabricated by incorporating cross-linking bond, functional groups or motifs that are sensitive to certain environment changes. In one embodiment, the inner layer 18 contains a pH responsive polymer and dissolution of the inner layer 18 is triggered by pH of the aqueous media to which the packaging system 10 and acidic product 12 is added. The pH responsive polymer of the inner layer 18 is water-soluble only in specific pH ranges and is not water-soluble when outside a specific pH range. In one embodiment, the inner layer 18 is water-soluble at alkaline or neutral pH values. In one embodiment, the inner layer 18 is not water-soluble in a pH environment below 5.5. When the water-soluble package contacts water or other aqueous media having a pH of greater than 5.5, the package will dissolve and will release the acidic product 12 into the water or other aqueous media. The inner layer 18 is stable at the highly acidic pH of the acidic treatment product, but breaks down rapidly at a less acidic (relatively more basic) pH. For example, acidic treatment product (pH˜3) will not dissolve the inner layer 18, but the inner layer 18 will dissolve in the higher pH (above pH 5.5) environment present in the environment.

pH-sensitive polymers for the inner layer 18 contains acidic or alkaline functional groups that respond to changes in pH. A pH change around the pKa value (dissolution pH) of the functional groups results in the ionization of the group and generates electrostatic repulsive forces lead to disintegration of the polymer network. Materials with dissolution pH in range of 5˜8 can be used for pH triggered inner layer 18. Typical examples may include alkyl acrylate-methacrylic acid copolymers, alkyl methacrylate-methacrylic acid copolymers, alkyl acrylate-acrylic acid copolymers, alkyl methacrylate-acrylic acid copolymers, cellulose acetate phthalate (CAP), cellulose acetate succinate, hydroxy propyl methyl cellulose phthalate, hydroxy propyl methyl cellulose acetate succinate (hypromellose acetate succinate), polyvinyl acetate phthalate (PVAP), sodium alginate and stearic acid, modified chitosan, poly(L-lysine), poly(L-histidine). Suitable pH responsive acrylic polymers commercially available are Eudragit® methacrylic acid copolymers available from Evonik Röhm GmbH of Darmstadt, Germany. One suitable example is Eudragit® L100-55. Eudragit® methacrylic acid copolymers dissolve between pH 5.5 and pH greater than 7. The coating solution may also contain suitable plasticizers, such as PEG 6000 or triethyl citrate, or other additives dissolved in non-aqueous solvent such as ethanol or propoxy ethanol.

The multi-layer water soluble film that possess pH-dependent solubility can be generated by coating the pH-sensitive polymer onto the water soluble outer layer 16, such as a PVA film. The conventional PVA film outer layer 16 provide structure integrity to the packaging system 10, while the pH-sensitive polymer inner layer 18 controls the release of encapsulated acidic product 12 when pH exceed a critical value.

The polymer of the inner layer 18 may respond to diverse stimuli other than pH, such as temperature, light, pressure, electrical field, chemicals, or ionic strength or a combination thereof. Accordingly, other triggers for re-solublizing the water soluble coating may include salt (or ionic strength) triggered dissolution, temperature triggered dissolution, magnetic field triggered dissolution, dissolved oxygen, CO₂ or other dissolved gases triggered, hypochlorous/hypobromous acid concentration, H₂S concentration (dissolved sulfides), volatile fatty acids, specific metal (e.g., Fe, Cu, Mo Mn,) concentrations, silica, calcium salts such as carbonate, phosphate, sulfite, ammonia and ammonium salts, or EDTA (or other specific molecule) triggered dissolution.

The multi-layer film 14 may be prepared by any conventional manner. In one embodiment, the multi-layer film 14 may be prepared by solution casting the outer layer 16 or film and laminating the inner layer 18 or film to the outer layer 16. For example, the layers may be laminated together, may be attached with an adhesive or may be coextruded together. In one embodiment, the layers are laminated together by heating the layers or by pressing the layers together. In another embodiment, an inner layer 18 is extrusion coated onto the outer layer 16. Other known ways of preparing the multi-layer film 14 may also be used.

A solution of the polymer for the inner layer 18 may be prepared to aid in preparing the multi-layer film 14. In one embodiment, a solution is prepared by adding the polymer for the inner layer 18 to a solvent. The solvent may be an organic solvent. In one embodiment, the solvent is ethanol. Additional components may be added to the casting solution, such as triethyl citrate or polyethylene glycol. In one embodiment, the polymer solution for the inner layer 18 may include a polymer in an amount of from about 10 percent by weight to about 20 percent by weight, triethyl citrate in an amount of from about 1 percent by weight to about 5 percent by weight and a solvent in an amount of from about 80 percent by weight to about 90 percent by weight, based on the weight of the solution.

The multi-layer film 14 may be any thickness suitable for providing support for the acidic product 12 and strength to the packaging system 10. In one embodiment, the multi-layer film 14 thickness is from about 0.5 (12.7 μm) to about 10 mils (254 μm). In another embodiment, the thickness may be in a range of from about 2 mils (51 μm) to about 4 mils (102 μm).

In one embodiment, the acidic product 12 is encapsulated in the packaging system 10 contacting the inner layer 18. The inner layer 18 of the packaging system 10 will not dissolve or degrade from the acidic product 12 containing water and maintains a stable packaging for the encapsulated acidic product 12. The package system will dissolve and release the product when the pH of a water or aqueous media, such as cooling water, is increased to above about 5.5.

The packaging system 10 may be in any desired form or shape. In one embodiment, the multi-layer film 14 may be formed into a bag, packet or sachet. In another embodiment, the packaging system 10 may be round, square or rectangular. The packaging system 10 may be formed from one or more sheets of the multi-layer film 14 or from a tubular section of the film. In one embodiment, the multi-layer film 14 is formed into the packaging system 10 with the inner layer 18 on the inside of the package and the outer layer 16 on the outside of the package. In one embodiment, the acidic product 12 is placed inside the formed package and sealed. In one embodiment, two pieces of multi-layer film 14 are placed together with the inner layers 18 contacting each other and the edges sealed to form a package. In another embodiment, a piece of multi-layer film 14 is folded over to create the packaging system 10 in which the inner layers 18 are inside the package and the open edges are sealed. In one embodiment, the acidic product 12 may be placed on one piece of the multi-layer film 14 in contact with the inner layer 18 and another multi-layer film 14 or piece of film is placed on the acidic product 12 in contact with the inner layer 18 and the multi-layer film 14 pieces of film are sealed around the edges. The package may be sealed in any suitable manner. In one embodiment, the package film is heat sealed. In another embodiment, the method for making the multi-layer film 14 includes laminating the outer layer 16 to the inner layer 18. The layers may be laminated together by heat or pressing the layers together. In another embodiment, the package film is sealed by using adhesives. The amount of acidic product 12 in the package will depend on the desired dosing amount.

In one embodiment, the triggered dissolution can be used to provide stable packaging for water treatment product and can also effectively release the encapsulated product when changes in water chemistry exceed critical parameter. For example, with respect to the pH triggered dissolution example described above, packaging systems 10 containing acidic product 12 could be added to an industrial water system. The outer layer 16 will dissolve upon addition to the industrial water system, but the inner layer 18 will only dissolve once the water in the industrial water system reaches the pH level necessary to trigger dissolution of the inner layer 18. Accordingly, the acidic product may be pre-fed to the industrial system, but will only be released to the water in the system once the environmental triggering parameter is reached.

In order that those skilled in the art will be better able to practice the present disclosure, the following examples are given by way of illustration and not by way of limitation.

### EXAMPLE

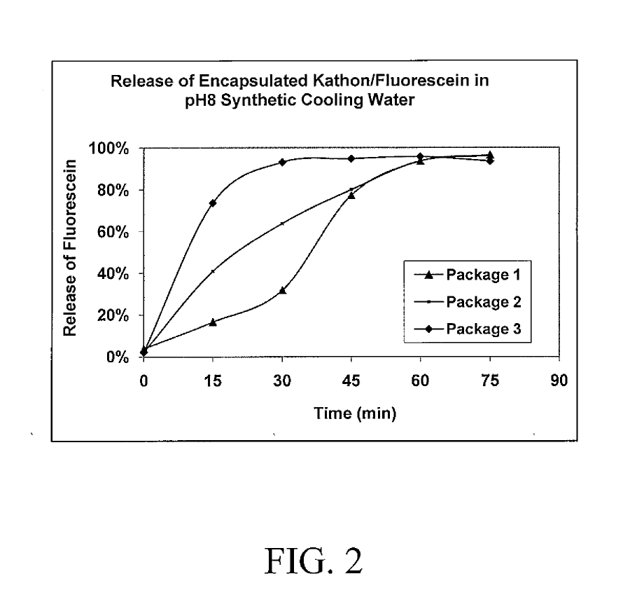

Multi-layer water-soluble films that possess pH-dependent solubility were generated by coating a pH-sensitive polymer onto existing water-soluble PVA film. The conventional PVA film provide structure integrity to the packaging film while the pH-sensitive polymer layer control the release of encapsulated product when pH exceed a critical value. The product was an isothiazoline biocide (commercial name Kathon® 886F). pH-sensitive polymers used were commercially available Eudragit® acrylic polymers. An example of coating solution contains acrylic polymer Eudragit® L100-55 and suitable plasticizers, such as PEG6000, dissolved in ethanol. FIG. 2 illustrates timing of the release of encapsulated Kathon/Fluorescein in pH 8 synthetic cooling water. The tested packages were prepared by coating 35-micrometer thick commercial PVA film with pH-sensitive film formulation. The pH-sensitive film for package No. 1 contained 12.5% Eudragit® L100-55 and 87.5% ethanol; package No. 2 contained 12.5% Eudragit® L100-55, 1.25% PEG6000, and 86.25% ethanol; and package No. 3 contained 12.5% Eudragit® L100-55, 2.5% PEG6000, and 85% ethanol.

The multi-layer film 14 can be generated by applying the above coating formulation onto an existing 35 micrometer thick texturized cold water-soluble PVA film by means of a doctor blade using an Erichsen Coatmaster 509 MC device at a coating speed of 12.5 cm/min. A film applicator with a wet thickness of 120 micrometer was used to achieve a dry thickness of 16-18 micrometers. After drying, the coated PVA film at 60° C. for 30 minutes, additional coating layers can be applied to achieve a thicker dry film.

As seen in FIG. 2, the liquid biocide product isothiazoline (commercial name Kathon 886F) having a water content of 60% and a product pH less than 4.0 was successfully loaded into packages made from the above pH-sensitive film. The packaged isothiazoline biocide product demonstrated good stability and was stable for up to 3 months at ambient and 21 days at 50° C. For the convenience of studying package dissolution and product release properties, a small amount of fluorescent tracer was added to isothiazoline biocide. When the packaged isothiazoline biocide was added to synthetic cooling water of pH 8, which is above the dissolution pH of Eudragit acrylic polymer, the isothiazoline biocide package slowly dispersed and released the biocide and fluorescent tracer into the water stream.

While the disclosure has been illustrated and described in typical embodiments, it is not intended to be limited to the details shown, since various modifications and substitutions can be made without departing in any way from the spirit of the present disclosure. As such, further modifications and equivalents of the disclosure herein disclosed may occur to persons skilled in the art using no more than routine experimentation, and all such modifications and equivalents are believed to be within the scope of the disclosure as defined by the following claims.

What is claimed is:

1. A packaging system for an acidic product, said acidic product having an acidic pH, the packaging system comprising a multi-layer packaging film having a water-soluble outer layer and an inner layer comprising a pH-sensitive polymer that is stable at the pH of the acidic product and dissolves when exposed to a dissolution pH, said dissolution pH being greater than the pH of the acidic product.

2. The packaging system of claim 1 wherein the pH-sensitive polymer has a dissolution pH of between 5 to 8.

3. The packaging system of claim 1 wherein the pH-sensitive polymer is selected from the group consisting of alkyl acrylate-methacrylic acid copolymers, alkyl methacrylate-methacrylic acid copolymers, alkyl acrylate-acrylic acid copolymers, alkyl methacrylate-acrylic acid copolymers, cellulose acetate phthalate (CAP), cellulose acetate succinate, hydroxy propyl methyl cellulose phthalate, hydroxy propyl methyl cellulose acetate succinate (hypromellose acetate succinate), polyvinyl acetate phthalate (PVAP), sodium alginate and stearic acid, modified chitosan, poly(L-lysine), and poly(L-histidine).

4. The packaging system of claim 3 wherein the pH sensitive polymer is selected from the group consisting of cellulose acetate phthalate (CAP), alkyl acrylate-methacrylic acid copolymers, alkyl methacrylate-methacrylic acid copolymers, alkyl acrylate-acrylic acid copolymers or alkyl methacrylate-acrylic acid copolymers.

5. The packaging system of claim 3 wherein the pH sensitive polymer is ethyl acrylate-methacrylic acid copolymer.

6. The package system of claim 1 wherein the water-soluble film is a film forming water soluble polymer selected from the group consisting of modified starch, modified cellulose, modified chitosan, polyethylene oxide, poly(ethylene oxide-co-propylene oxide), poly ethylene glycol, polyvinyl alcohol, pollulan, gelatin, proteins, polypeptides, and their derivatives.

7. The package system of claim 1 wherein the water soluble film of claim 6 is a polyvinyl alcohol.

8. The package system of claim 1 wherein pH of the acidic product is less than the dissolution pH.

9. A method for adding an acidic product treatment chemical to a water system, the method comprising:
providing a multi-layer film having an outer layer attached to an inner layer, wherein the outer layer is water-soluble and the inner layer comprises a pH-sensitive polymer that is stable at the pH of the acidic product and dissolves when exposed to a dissolution pH, said dissolution pH being greater than the pH of the acidic product;
encapsulating the acidic product in a packaging system comprising the multi-layer film such that the acidic product contacts the inner layer;
adding the packaging system to the water system;
dissolving the outer layer of the multi-layer film on contact with the water system; and
dissolving the inner layer of the multi-layer film when the pH of the water system is greater than the dissolution pH at which the pH-sensitive polymer of the inner layer dissolves to release the acidic product to the water system.

10. The method for adding an acidic product treatment chemical to a water system according to claim 9 wherein the inner layer is dissolved at a pH at or above dissolution pH to release the acidic product to the water system.

11. The method for adding an acidic product treatment chemical to a water system according to claim 9 wherein the multilayer film is prepared with a pH-sensitive polymer selected from the group consisting of alkyl acrylate-methacrylic acid copolymers, alkyl methacrylate-methacrylic acid copolymers, alkyl acrylate-acrylic acid copolymers, alkyl methacrylate-acrylic acid copolymers, cellulose acetate phthalate (CAP), cellulose acetate succinate, hydroxy propyl methyl cellulose phthalate, hydroxy propyl methyl cellulose acetate succinate (hypromellose acetate succinate), polyvinyl acetate phthalate (PVAP), sodium alginate and stearic acid, modified chitosan, poly(L-lysine), and poly(L-histidine).

12. The method for adding an acidic product treatment chemical to a water system according to claim 11 wherein the multilayer film is prepared with a pH-sensitive polymer selected from the group consisting of cellulose acetate phthalate (CAP), alkyl acrylate-methacrylic acid copolymers, alkyl methacrylate-methacrylic acid copolymers, alkyl acrylate-acrylic acid copolymers or alkyl methacrylate-acrylic acid copolymers.

13. The method for adding an acidic product treatment chemical to a water system according to claim 11 wherein the pH sensitive polymer is ethyl acrylate-methacrylic acid copolymer.

14. The method for adding an acidic product treatment chemical to a water system according to claim 9 wherein the water-soluble film is prepared with a film forming water soluble polymer selected from the group consisting of modified starch, modified cellulose, modified chitosan, polyethylene oxide, poly(ethylene oxide-co-propylene oxide), poly ethylene glycol, polyvinyl alcohol, pollulan, gelatin, proteins, polypeptides, and their derivatives.

15. The method for adding an acidic product treatment chemical to a water system according to claim 9 wherein the water soluble film is a polyvinyl alcohol.
